(19) United States
(12) Patent Application Publication
(10) Pub. No.: US 2026/0274416 A1
(43) Pub. Date: Sep. 17, 2026

(54) Holder for a Liquid Container for use in a UAV Delivery Package

(71) Applicant: Wing Aviation LLC, Palo Alto, CA (US)

(72) Inventors: Aaron Bryce Christian, Redwood City, CA (US); Evan Scott Twyford, Houston, TX (US)

(21) Appl. No.: 19/080,836

(22) Filed: Mar. 15, 2025

(51) Int. Cl. B64D 1/22; B64U 101/66; B65D 71/42

(52) U.S. Cl. CPC B64D 1/22; B65D 71/42; B64U 2101/66; B65D 2571/00524

(57) ABSTRACT

A holder for a liquid container includes a sheet of material that is deployable into an operational state. In the operational state, the sheet of material forms a top panel including a first edge, a second edge opposite the first edge, and an aperture positioned between the first edge and the second edge. The aperture is configured to receive a liquid container. The sheet of material also forms a first support panel that is coupled to the first edge of the top panel along a first curved crease and that extends down from the top panel, and a second support panel coupled to the second edge of the top panel along a second curved crease and that extends down from the top panel.

### BACKGROUND

An uncrewed vehicle, which may also be referred to as an autonomous vehicle, is a vehicle capable of travel without a physically-present human operator. The term “unmanned” may sometimes be used instead of, or in addition to, “uncrewed,” and it should be understood that both terms have the same meaning, and may be used interchangeably. An uncrewed vehicle may operate in a remote-control mode, in an autonomous mode, or in a partially autonomous mode.

Various types of uncrewed vehicles exist for various different environments. For instance, uncrewed vehicles exist for operation in the air, on the ground, underwater, and in space. Examples include quad-copters and tail-sitter UAVs, among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

The present embodiments are directed to a holder that is configured to center and stabilize an object, such as a liquid container, within a package during delivery by a UAV.

In one aspect a holder is provided. The holder includes a sheet of material that is deployable into an operational state. In the operational state, the sheet of material forms a top panel including a first edge, a second edge opposite the first edge, and an aperture positioned between the first edge and the second edge. The aperture is configured to receive a liquid container. The sheet of material also forms a first support panel that is coupled to the first edge of the top panel along a first curved crease and that extends down from the top panel, and a second support panel coupled to the second edge of the top panel along a second curved crease and that extends down from the top panel.

In another aspect a package is provided. The package includes a payload container and a holder for a liquid container positioned inside the payload container. The payload container includes a bottom face, a closeable top, and a side wall extending between the bottom face and the closeable top. The holder includes a sheet of material that is deployable into an operational state. In the operational state, the sheet of material forms a top panel including a first edge, a second edge opposite the first edge, and an aperture positioned between the first edge and the second edge. The aperture is configured to receive a liquid container. The sheet of material also forms a first support panel that is coupled to the first edge of the top panel along a first curved crease and that extends down from the top panel, and a second support panel coupled to the second edge of the top panel along a second curved crease and that extends down from the top panel.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an uncrewed aerial vehicle, in accordance with examples described herein.

FIG. 2 illustrates components of an uncrewed aerial system, in accordance with examples described herein.

FIG. 3 is a block diagram illustrating a distributed UAV system, in accordance with examples described herein.

FIGS. 4A, 4B, and 4C illustrate an example delivery method using a UAV according to an example.

FIG. 5 shows a perspective view of a payload handling system according to an example.

FIG. 6 shows a perspective view of a payload retriever according to an example.

FIG. 7 shows a side view of a hanger of a payload according to an example.

FIG. 8 shows a perspective view of a holder for a liquid container according to an example of the disclosure.

FIG. 9 schematically depicts an example package containing the holder of FIG. 8 supporting a liquid container.

FIG. 10A shows the holder of FIG. 8 in a collapsed state.

FIG. 10B shows the holder of FIG. 8 in an operational state.

FIG. 11 shows the holder inside the package of FIG. 9, with a portion of the package removed.

FIG. 12 shows a portion of the holder of FIG. 8.

FIG. 13 shows a die-cut material sheet for forming the holder of FIG. 8.

FIG. 14 shows another die-cut material sheet for forming a holder according to another example of the disclosure.

FIG. 15 shows a perspective view of another example of a holder for a liquid container.

FIG. 16 shows a perspective view of the holder and package of FIG. 11 holding another object.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

The present embodiments are related to a holder designed for liquid containers, particularly for use in packages that are adapted for delivery by a UAV. The holder may be made from a sheet of material, such as paperboard, and includes a top panel with an aperture to secure the liquid container. Support panels extend down from the top panel and hold the top panel around the liquid container when in use. The holder may be folded into a flat, collapsed state for efficient storage and shipping, and expanded into an operational state. The holder's structural stability is enhanced by curved creases between the top panel and support panels. The curved creases create localized stresses that resist deformation and help the holder maintain its shape.

The holder may also have a bistable configuration, allowing it to “snap” into the operational state. The liquid container itself may contribute to the holder's stability by acting as a structural support and by urging the holder towards its operational state. Retaining tabs may be positioned around the aperture to help secure and center various-sized liquid containers within the.

The holder may be designed to fit securely within a package to prevent the holder from moving during delivery. The holder may be sized to match the package so that each of the two support panels will brace against opposing portions of a side wall of the package. In some examples, additional securing methods like adhesive strips or mechanical connections, can be used to further secure the holder inside the package.

Further details and various embodiments of a holder for a liquid container are described below.

### II. Example Uncrewed Vehicles

Herein, the terms “unmanned aerial system,” “uncrewed aerial system,” “unmanned aerial vehicle,” “uncrewed aerial vehicle,” and/or “UAV” are used synonymously and refer to any autonomous or semi-autonomous vehicle that is capable of performing some functions without a physically present human pilot. A UAV can take various forms. For example, a UAV may take the form of and/or include aspects of a fixed-wing aircraft, a glider aircraft, a tail-sitter aircraft, a jet aircraft, a pusher propeller plane, a ducted fan aircraft, a lighter-than-air dirigible such as a blimp or steerable balloon, a rotorcraft such as a helicopter or multicopter (e.g., quadcopter), and/or an ornithopter, among other possibilities. Further, the terms “drone” and/or “uncrewed aerial vehicle system” (“UAVS”) may also be used to refer to a UAV.

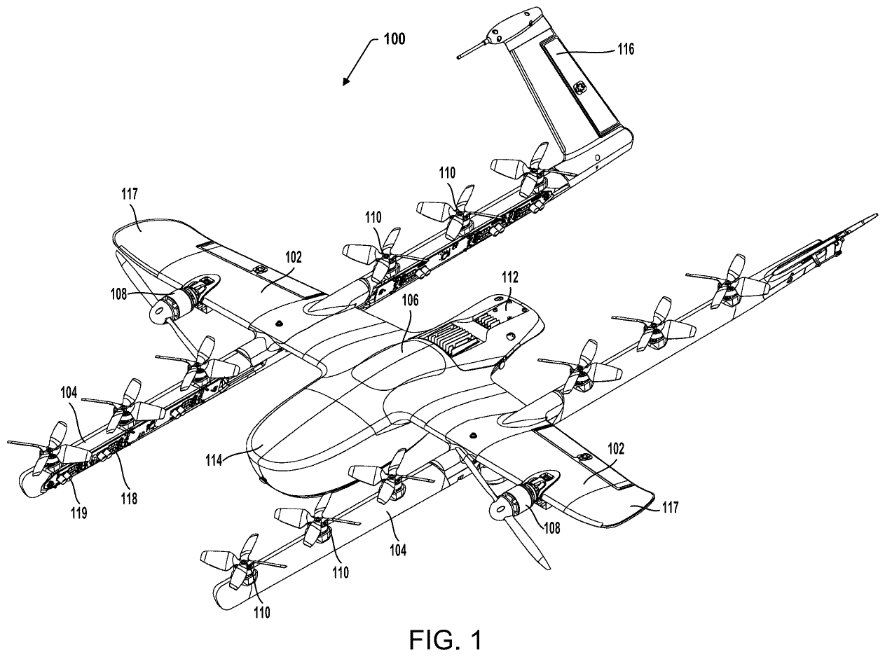

FIG. 1 provides an isometric view of an example UAV 100. UAV 100 includes wings 102, booms 104, and fuselage 106. Wings 102 may be stationary and may generate lift based on the wing shape and the forward airspeed of UAV 100. For instance, wings 102 may have an airfoil-shaped cross section to produce an aerodynamic force on UAV 100. In some embodiments, wings 102 may carry horizontal propulsion units 108, and booms 104 may carry vertical propulsion units 110. In some embodiments, the rear end of booms 104 may include control surfaces 116 for improving control of UAV 100 (e.g., yaw control). Further, wings 102 may terminate in wing tips 117 for improved control of lift of the UAV. In operation, power for the propulsion units may be provided from a battery compartment 112 of fuselage 106. Fuselage 106 may also include avionics compartment 114, an additional battery compartment (not shown), and/or a delivery unit (not shown, e.g., a winch system) for handling a payload.

Fuselage 106 may be modular, and two or more compartments (e.g., battery compartment 112, avionics compartment 114, and/or other payload and delivery compartments) may be detachable from each other and securable to each other (e.g., mechanically, magnetically, and/or otherwise) to contiguously form at least a portion of fuselage 106. UAV 100 may include a structural frame, which may be referred to as a “structural H-frame” or an “H-frame” of the UAV. The H-frame may include, within wings 102, a wing spar (not shown) and, within booms 104, boom carriers (not shown). Horizontal propulsion units 108 may be connected to the wing spar, and vertical propulsion units 110 may be connected to the boom carriers. Fuselage 106 may be removably attached to the H-frame and/or to wings 102. In some cases, different types/models of fuselage 106 may be attached to the H-frame. In some embodiments, wing shell(s) and/or boom shell(s) may be removably attached to the H-frame. For example, the same H-frame may be used with wing shell(s) and/or boom shell(s) having different size(s) and/or design(s), therefore improving the modularity and versatility of the UAV designs.

The power and/or control signals from fuselage 106 may be routed to PCBs 118 through cables running through fuselage 106, wings 102, and/or booms 104. In the illustrated embodiment, UAV 100 has four PCBs 118, but other numbers of PCBs (e.g., two PCBs, one per the boom) are also possible. PCBs 118 may carry electronic components 119 including, for example, power converters, controllers, memory, and/or passive components, among others. Horizontal propulsion units 108 and/or 110 of UAV 100 may be electrically connected to PCBs 118.

Many variations of UAV 100 are possible. For example, while FIG. 1 illustrates two wings 102, two booms 104, two horizontal propulsion units 108, and four vertical propulsion units 110 per boom 104, it should be appreciated that other variants of UAV 100 may be implemented with more or fewer of these components. For example, a UAV may include four wings 102 (e.g., forming an “x-wing” configuration), four booms 104, and more or fewer propulsion units (horizontal or vertical). The UAV may include a vertical stabilizer, a horizontal stabilizer, an elevator, a flap, a rudder, an aileron, a slat, and/or a spoiler to allow for stabilization and/or control of a yaw, pitch, and/or roll of the UAV.

In an autonomous implementation, all functionality of the aerial vehicle may be automated (e.g., pre-programmed and/or controlled via real-time computer functionality that responds to input from various sensors and/or pre-determined information). In a semi-autonomous implementation, some functions of the aerial vehicle may be controlled by a human operator, while other functions are carried out autonomously. In some cases, a UAV may be configured to allow a remote operator to take over functions of the aerial vehicle that can otherwise be performed autonomously by the UAV. In some cases, the UAV may autonomously operate to execute operations specified by the remote operator.

### III. Example UAV Components

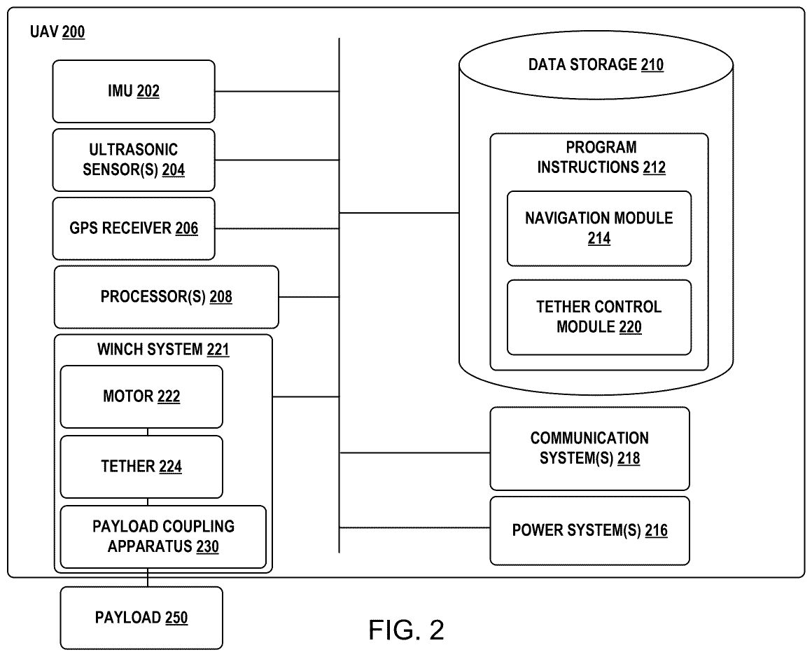

FIG. 2 is a simplified block diagram illustrating example components of UAV 200. UAV 200 may take the form of and/or be similar in form to UAV 100. In general, any aerial vehicle and/or UAV discussed herein may include features of UAV 100, UAV 200, and/or a combination thereof. However, UAV 200 may also take other forms. UAV 200 may include a computing system configured to provide at least some of the functionality and/or operations described herein. UAV 200 may include various types of sensors, including inertial measurement unit (IMU) 202, ultrasonic sensor(s) 204, and GPS receiver 206, among other possibilities.

UAV 200 may also include processor(s) 208, which may include a general-purpose processor and/or a special purpose processor (e.g., digital signal processor (“DSP”), application specific integrated circuit (“ASIC”), tensor processing unit (“TPU”), etc.). Processor(s) 208 may be configured to execute computer-readable program instructions 212 that are stored in data storage 210 and are executable to provide the functionality and/or operations described herein.

Data storage 210 may include and/or take the form of one or more computer-readable storage media that can be read and/or accessed by processor(s) 208. The one or more computer-readable storage media may include volatile and/or non-volatile storage components (e.g., memory and/or disc storage, which may be implemented using optical, magnetic, organic, and/or other types of components), which can be integrated in whole or in part with at least one of processor(s) 208. Data storage 210 may be implemented using one or more physical devices. Data storage 210 may include computer-readable program instructions 212, which may be configured to perform and/or facilitate some or all of the UAV functionality/operations described herein. For example, program instructions 212 may include navigation module 214 and tether control module 220.

IMU 202 may include an accelerometer and/or a gyroscope, which may be used together to determine an orientation of UAV 200. The accelerometer may be used to measure the orientation of UAV 200 with respect to the earth, while the gyroscope may be used to measure the rate of rotation of UAV 200 around an axis. IMU 202 may take the form of and/or may include a miniaturized MicroElectroMechanical System (MEMS) and/or a NanoElectroMechanical System (NEMS), among other possibilities. IMU 202 may also include other sensors, such as magnetometers (e.g., a 3-axis magnetometer to be used as a compass) and/or pressure sensors, which may assist with determining the position, orientation, and/or motion of UAV 200. In some implementations, UAV 200 may include some or all of the above-described sensors as separate components from IMU 202.

UAV 200 may also include a pressure sensor or barometer, which can be used to determine the altitude of UAV 200. Alternatively or additionally, other sensors, such as sonic altimeters and/or radar altimeters, can be used to provide an indication of altitude of UAV 200, which may help to improve the accuracy of and/or prevent drift of IMU 202.

UAV 200 may also include one or more sensors that allow UAV 200 to sense objects in the environment. For instance, UAV 200 may include ultrasonic sensor(s) 204, which can determine the distance to an object by generating a sound wave and determining the time interval between transmission of the sound wave and reception of the corresponding echo of the sound wave from the object. Ultrasonic sensor(s) 204 may be used for low-level altitude control and/or obstacle avoidance. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

UAV 200 may also include one or more imaging system(s), such as one or more cameras configured to capture image data from the UAV's environment. Image data captured by the imaging system(s) may be used for obstacle avoidance, UAV localization, ground tracking for more accurate navigation (e.g., by applying optical flow techniques to images), video feedback, and/or image recognition and processing, among other possibilities.

UAV 200 may also include GPS receiver 206. GPS receiver 206 may be configured to provide data that is typical of well-known GPS systems, such as the GPS coordinates of UAV 200. UAV 200 may use GPS receiver 206 to help navigate to various geographic locations (e.g., a payload pick-up location, a payload drop-off location, etc.).

Navigation module 214 may allow UAV 200 to, for example, move about its environment and reach a desired location. To do so, navigation module 214 may control the altitude and/or direction of flight of UAV 200 by controlling mechanical components of UAV 200 that affect flight (e.g., its rudder(s), elevator(s), aileron(s), and/or the speed of its propeller(s)).

To navigate UAV 200 to a target location, navigation module 214 may implement various navigation techniques, such as map-based navigation and localization-based navigation. With map-based navigation, UAV 200 may be provided with a map of its environment, which may then be used to navigate to a particular location on the map. With localization-based navigation, UAV 200 may be capable of navigating in an unknown environment using localization. Localization-based navigation may involve UAV 200 building its own map of the environment and calculating its position within the map and/or the position of objects in the environment. For example, as UAV 200 moves throughout its environment, UAV 200 may continuously use localization to update its map of the environment. This continuous mapping process may be referred to as simultaneous localization and mapping (SLAM). Other navigation techniques may also be utilized.

In some embodiments, navigation module 214 may utilize waypoints for navigation. In particular, waypoints are sets of coordinates that identify points in physical space. For instance, an air-navigation waypoint may be defined by a specific latitude, longitude, and altitude. Accordingly, navigation module 214 may cause UAV 200 to move from waypoint to waypoint, in order to ultimately travel to a final destination (e.g., a final waypoint in a sequence of waypoints). In some cases, UAV 200 may switch to a remote control mode where it is controlled, at least in part, by a remote operator, who can navigate UAV 200 to the target location. To this end, sensory data from UAV 200 may be sent to the remote operator to assist them in navigating UAV 200 to the target location.

UAV 200 may include communication system(s) 218. Communications system(s) 218 may include wireless interface(s) and/or wireline interface(s), which may allow UAV 200 to communicate via one or more networks. The wireless interface(s) may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. Communication system(s) 218 that allow for short-range communication (e.g., using BLUETOOTH) and/or long-range communication (e.g., using an LTE network).

UAV 200 may include power system(s) 216, which may include a battery for providing power to UAV 200. The battery may be rechargeable using, for example, a wired connection between the battery and a power supply and/or a wireless charging system (e.g., an inductive charging system that applies an external time-varying magnetic field to the battery).

UAV 200 may be configured to transport and deliver payload 250. In some cases, payload 250 may include a “package” designed to be loaded with one or more items for transportation to a target delivery location. The one or more items may include food item(s), medical item(s), and/or any other object(s) having a size and weight suitable for transportation between two locations by UAV 200. In other cases, payload 250 may take the form of the one or more items without any package housing these items.

In some cases, UAV 200 may include a compartment, in which payload 250 may be transported. In other cases, payload 250 may be attached to UAV 200 and located substantially outside of a body of UAV 200 during some or all of the flight of UAV 200. For example, payload 250 may be tethered or otherwise releasably attached below UAV 200 during the flight to the target location. In cases where a package carries goods below UAV 200, the package may include various features that protect its contents from the environment, reduce aerodynamic drag on UAV 200, and/or prevent the contents of the package from shifting during flight.

UAV 200 may include winch system 221, which may be controlled by tether control module 220. Winch system 221 may include tether 224, which may be coupled to payload 250 by payload coupling apparatus 230. Tether 224 may be wound on a spool that is coupled to motor 222 of UAV 200. Motor 222 may take the form of a DC motor (e.g., a servo motor). Tether control module 220 may control the speed and/or position of motor 222 to rotate the spool, thereby unwinding or retracting tether 224 and lowering or raising, respectively, payload coupling apparatus 230.

Tether control module 220 may receive data from a position sensor and/or a speed sensor, such as an encoder, configured to convert a mechanical position to a representative analog or digital signal. The encoder may include a rotary encoder that may provide information related to rotational/angular position and/or a rotational/angular velocity of a shaft of motor 222 and/or the spool coupled to motor 222, among other possibilities. The encoder may be and/or may include an absolute encoder and/or an incremental encoder. Tether control module 220 may use, for example, a proportional-integral-derivative (PID) calculation to control motor 222 (e.g., by increasing or decreasing an electrical current supplied to motor 222) based on (i) a desired position and/or speed of motor 222 and (ii) the data from the position sensor and/or the speed sensor.

Payload coupling apparatus 230 may be configured to attach payload 250 to tether 224 during pickup of payload 250, secure payload 250 to UAV 200 during transport, and/or release payload 250 from UAV 200 after transport of payload 250 is completed. Thus, payload coupling apparatus 230 may be deployed from UAV 200 by unwinding tether 224 using motor 222 prior to and/or during pick-up of payload 250 and/or after drop-off of payload 250. Payload coupling apparatus 230 may also be retracted to UAV 200 by reeling in tether 224 using motor 222 after pick-up of payload 250 and/or after drop-off of payload 250.

In some implementations, some aspects of UAV 200 may be implemented using a remote computing device that communicates wirelessly with UAV 200. The remote computing device may receive data indicating the operational state of UAV 200, sensor data from UAV 200 that allows it to assess the environmental conditions being experienced by UAV 200, and/or location information for UAV 200. Provided with such information, the remote computing device may determine altitudinal and/or directional adjustments that should be made by UAV 200 and/or may determine how UAV 200 should adjust its mechanical features (e.g., its rudder(s), elevator(s), aileron(s), and/or the speed of its propeller(s)) in order to effectuate such movements. The remote computing system may then communicate such adjustments to UAV 200 so it can move in the determined manner.

### IV. Example UAV Deployment Systems

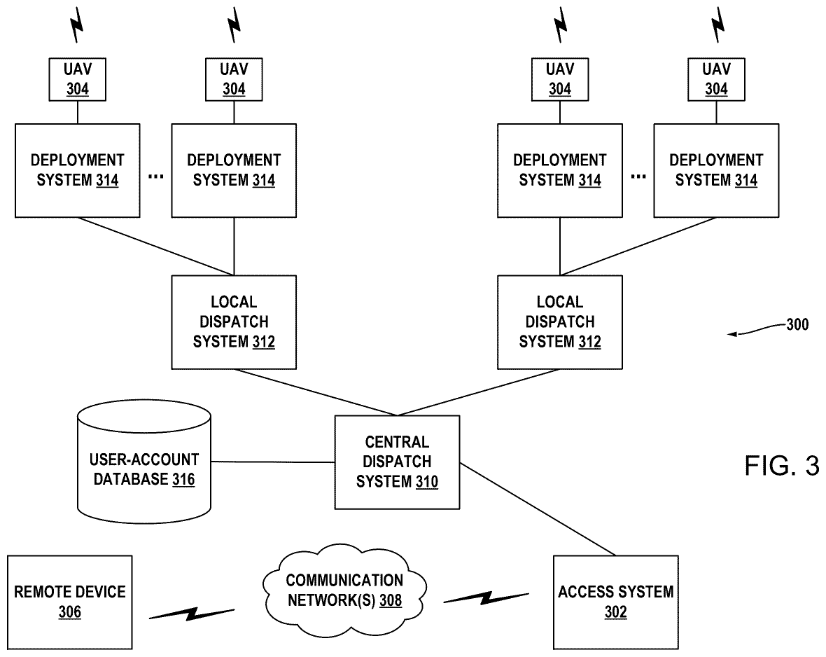

FIG. 3 is a simplified block diagram illustrating a distributed UAV system 300. UAV system 300 may include access system 302, remote device 306, communication network(s) 308, central dispatch system 310, user-account database 316, local dispatch systems 312, deployment systems 314, and UAVs 304. UAVs 304 may represent UAV 100 and/or UAV 200, among other possibilities. In some implementations, all of UAVs 304 may be of the same or a similar configuration. In other implementations, UAVs 304 may include a number of different types of UAVs. For example, UAVs 304 may include a plurality of types of UAVs, with each type of UAV being configured for different type(s) of payload delivery capabilities.

Access system 302 may allow for interaction with, control of, and/or utilization of a network of UAVs 304. In some embodiments, access system 302 may include a computing system that allows for human-controlled and/or automated dispatch of UAVs 304. For example, access system 302 may dispatch UAV 304 to transport a payload to a target location, and UAV 304 may autonomously navigate to the target location by utilizing various on-board sensors. In some implementations, access system 302 may provide for remote operation of UAVs 304.

Remote device 306 may be any device through which a request to dispatch a UAV can be made. Remote device 306 may be and/or include a mobile phone, tablet computer, laptop computer, personal computer, or any network-connected computing device. Remote device 306 may be configured to communicate with access system 302 via communication network(s) 308. Communication network(s) may include, for example, a cellular network, a Wi-Fi network, and/or a data network such as the Internet. In some embodiments, remote device 306 may be configured to allow a user to request pick-up of one or more items from a source location and/or delivery of one or more items to a destination location. In some cases, the source location and/or the destination location may be a geographic location associated with remote device 306. In some implementations, remote device 306 may be configured to communicate directly with central dispatch system 310 (rather than access system 302).

User-account database 316 may include data relating to a plurality of user accounts that may be used to request UAV-related services from UAV system 300. User-account database 316 may include authorization information for a given user account (e.g., a user name and password), location information representing pick-up and/or delivery location(s) associated with the given user account, and/or payment information associated with the given user account, among other possibilities.

Central dispatch system 310 may include one or more computing devices (e.g., servers) that may be configured to receive dispatch instructions/requests from access system 302. Such dispatch instructions may request and/or instruct central dispatch system 310 to coordinate the deployment of UAVs 304 to various target locations. Central dispatch system 310 may be configured to route the dispatch instructions/requests to one or more local dispatch systems 312. To provide such functionality, central dispatch system 310 may be configured to communicate with access system 302, user-account database 316, and/or local dispatch systems 312 via a data network, such as the Internet or a private network.

Central dispatch system 310 may be configured to coordinate the dispatch of UAVs 304 using a plurality of local dispatch systems 312. As such, central dispatch system 310 and/or local dispatch systems 312 may keep track of which ones of UAVs 304 are located at which ones of local dispatch systems 312, which UAVs 304 are currently available for deployment, and/or which services and/or operations each of UAVs 304 is configured for (in the event that a UAV fleet includes multiple types of UAVs configured for different services and/or operations).

In some cases, when central dispatch system 310 receives a request for UAV-related service (e.g., transport of an item) from access system 302, central dispatch system 310 may select a specific one of UAVs 304 to dispatch. Central dispatch system 310 may then instruct local dispatch system 312 that is associated with the selected UAV to dispatch the selected UAV. Local dispatch system 312 may then operate its associated deployment system 314 to launch the selected UAV. In other cases, central dispatch system 310 may forward a request for a UAV-related service to one of local dispatch systems 312 that is near the location where the service is requested and leave the selection of a particular one of UAVs 304 to local dispatch system 312.

In some implementations, local dispatch system 312 may include one or more computing devices, which may be located at or near the same location as deployment system(s) 314 that local dispatch system 312 controls. For example, a particular one of local dispatch systems 312 may be implemented by a computing device installed at a building, such as a warehouse, where deployment system(s) 314 and UAV(s) 304 that are associated with the particular one of local dispatch systems 312 are also located. In other embodiments, the particular one of local dispatch systems 312 may be implemented at a location that is remote to its associated deployment system(s) 314 and/or UAV(s) 304.

In some implementations, some or all of the functionality that is attributed herein to central dispatch system 310, local dispatch system(s) 312, access system 302, and/or deployment system(s) 314 may instead be provided by a single system, implemented using a more complex system (e.g., having more layers of control), and/or redistributed among central dispatch system 310, local dispatch system(s) 312, access system 302, and/or deployment system(s) 314 in various ways. Further, some implementations of UAV system 300 may include more or fewer instances of each component than shown in FIG. 3.

Each of deployment systems 314 may include a structure or system configured to facilitate take-off, landing, storage, charging, diagnostics, and/or maintenance of one or more of UAVs 304. For example, deployment systems 314 may include a landing pad, a hangar, and/or a runway, among other possibilities.

In some embodiments, local dispatch systems 312 and/or deployment system(s) 314 may be distributed throughout a geographic area (e.g., a city, a neighborhood, etc.). For example, local dispatch systems 312 may be distributed such that each of local dispatch systems 312 is proximate to one or more payload pickup locations (e.g., near a restaurant, store, warehouse, etc.). In some cases, local dispatch systems 312 and/or deployment systems 314 may be distributed to reduce or minimize a delay between request of a transport task and initiation of the transport task and/or to increase and/or maximize availability of deployment systems 314, among other possibilities. In general, any of the operations described herein may be performed by UAV 100, UAV 200, UAV system 300, a combination thereof, and/or one or more components thereof.

### V. Example Payload Delivery Systems

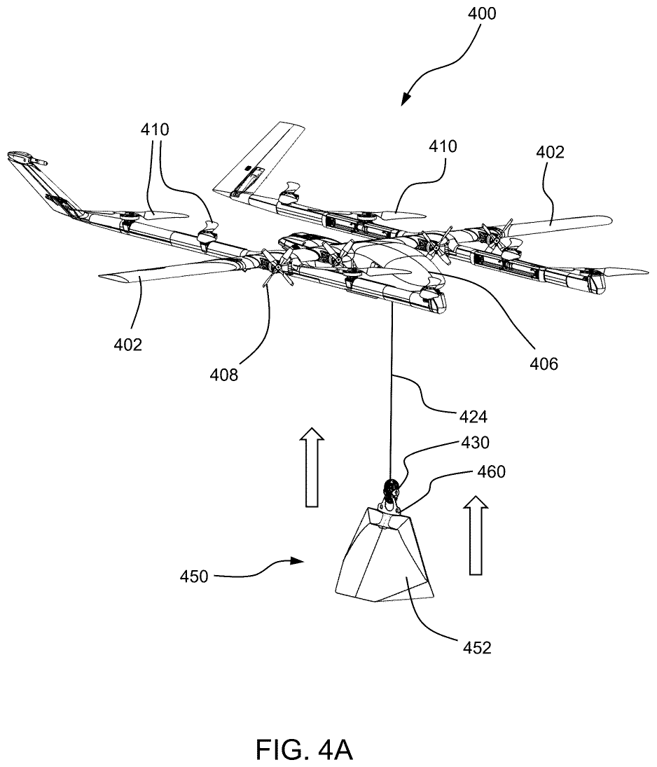

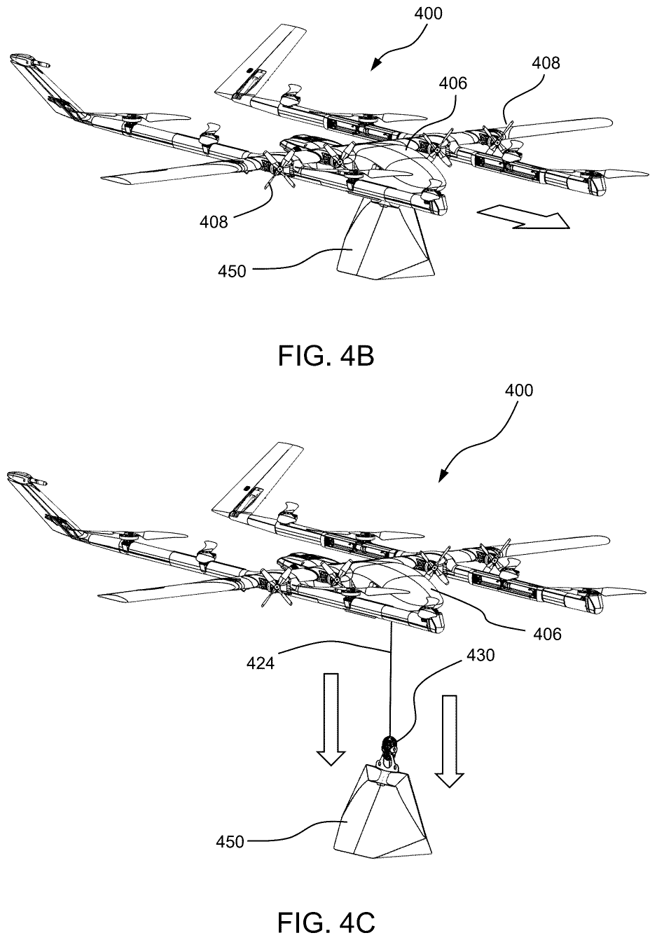

FIGS. 4A, 4B, and 4C illustrate aspects of a delivery process by a UAV 400 in accordance with an example of the disclosure. The illustrated UAV includes wings 402, thrust rotors 408 for forward movement, lift rotors 410 for vertical movement, and a fuselage 406 between the wings 402. However, aspects of this delivery process may be performed using aircraft of various different designs.

FIG. 4A shows the UAV 400 retrieving a payload 450 using a tether 424, for example at a payload retrieval site. The payload 450 is secured on an example payload retriever 430 (described in more detail below) that is attached to the tether 424. The payload includes a container 452 and a hanger 460 that is secured to the payload retriever 430. To hoist the payload 450 up to the fuselage 406, the tether 424 is being retracted into the fuselage 406 by a winch, as explained further below. In the illustrated example, while the payload 450 is lifted up to the fuselage 406, the UAV 400 is operating in a hover mode using the lift rotors 410. However, in other examples, the UAV may move laterally while the payload 450 is lifted.

FIG. 4B shows the UAV 400 with the payload 450 hoisted all the way up and secured to the fuselage 406. The fuselage 406 includes a slot for receiving a portion of the payload 450 and holding it in place, as described in more detail below. In FIG. 4B the UAV 400 is using thrust rotors 408 to fly from the retrieval site to a delivery site.

FIG. 4C shows the UAV 400 at the delivery site in a process of delivering the payload 450. Once at the delivery site, the UAV control system, or a payload handling control system of the UAV, may operate to release the payload from the fuselage 406, if applicable, and lower the payload 450 by extending the tether 424. Once the payload 450 reaches the ground, the control system may continue lowering the tether 424, causing over-run of the tether 424. During over-run of the tether 424, the payload retriever 430 may continue to lower as the payload 450 remains stationary on the ground. The downward momentum and/or gravitational force on the payload retriever 430 may cause the payload 450 to detach from the payload retriever 430 (e.g., by sliding off a hook of the payload retriever 430). After releasing the payload 450, the control system may retract the tether 424 and the payload retriever 430 toward the UAV 400.

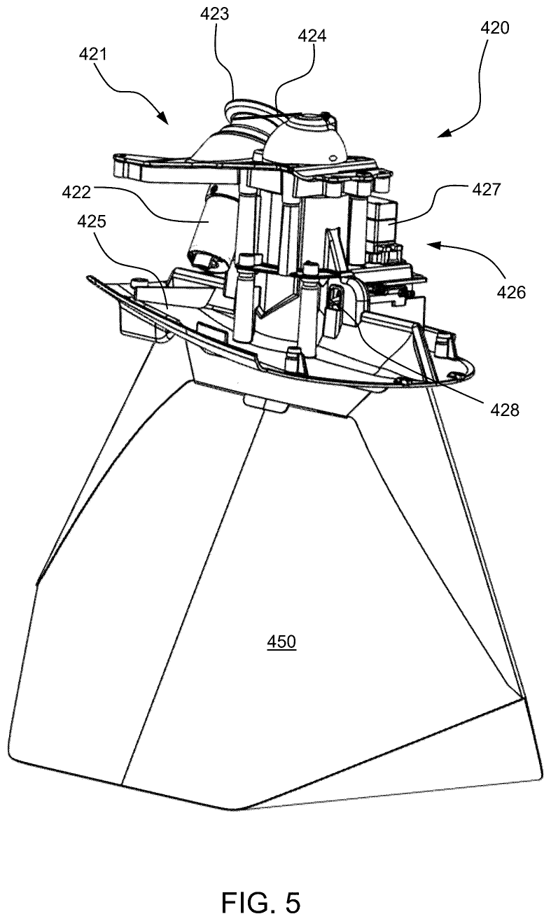

FIG. 5 shows a perspective view of a payload handling system 420, according to an example, with the payload 450 attached. In this illustrated example, the payload handling system 420 is adapted to be positioned within a fuselage of a UAV. For example, in the illustrated example, a support structure 425 of the payload handling system 420 forms part of the exterior surface of the fuselage and components of the payload handling system 420 are positioned inside the fuselage. In other examples, however, one or more components of the payload handling system may be held outside the fuselage. For instance, in some examples the payload handling system may be formed as part of a modular unit that connects to other portions of the UAV.

In the illustrated example, the payload handling system 420 includes a winch 421 that operates the tether 424 and a releasable coupler 426 that is adapted to secure the payload 450 to the UAV, as described in more detail below. The example winch 421 includes a motor 422 and a spool 423. The motor 422 drives the spool 423 to wind and unwind the tether 424 on the spool 423. In other examples, the winch may have a different configuration. For example, the winch may be formed as a capstan that extends and retracts a tether without winding the tether onto a spool. Likewise, the winch may include a spool or other wheel that is coupled to another actuator of the UAV, rather than having a dedicated motor. Other examples of a winch that operates to retract and extend a tether are also possible.

As stated above, the example payload handling system 420 also includes a releasable coupler 426. The releasable coupler 426 is configured to secure the payload 450 to the UAV independent of the tether 424 and payload retriever 430. Thus, the releasable coupler 426 provides another manner for securing the payload 450 to the UAV, and in some examples may be more secure than the attachment via the payload retriever. The releasable coupler 426 may be used as a redundant or alternative option for securing the payload to the UAV. When desired, the releasable coupler 426 may be actuated by the control system to release the payload 450 and allow the payload to be delivered.

In the illustrated example, the releasable coupler 426 is formed by an actuator 427 and a pair of pins 428 that extend through corresponding apertures in the payload. When the payload is in an appropriate position, the control system may operate the actuator 427 to insert the pins 428 through the apertures in the hanger. To prepare for delivery, the control system may operate the actuator again to remove the pins 428 from the apertures in the hanger. In other examples, the releasable coupler 426 may be biased toward a closed position, such that the actuator is only used for releasing the payload. For example, the pins may be spring loaded to the closed position and have a ramped surface to allow the hanger to pass. In such examples, as the hanger is drawn into the UAV, the pins are pushed out of the way. Once the pins align with the apertures in the hanger, they close under the force of the springs. To release the hanger, the control system operates the actuator to pull the pins out of the apertures.

While the illustrated example releasable coupler 426 includes a pair of pins 428 to hold the payload, the releasable coupler may have various other configurations. For example, the releasable coupler may be formed by a clamp, a claw, a latch, or some other fastener that secures the payload to the UAV. Further still, in some examples, the payload handling system 420 may be provided without a releasable coupler 426. In such examples, the payload may be secured to the UAV by another method, such as by the retriever alone.

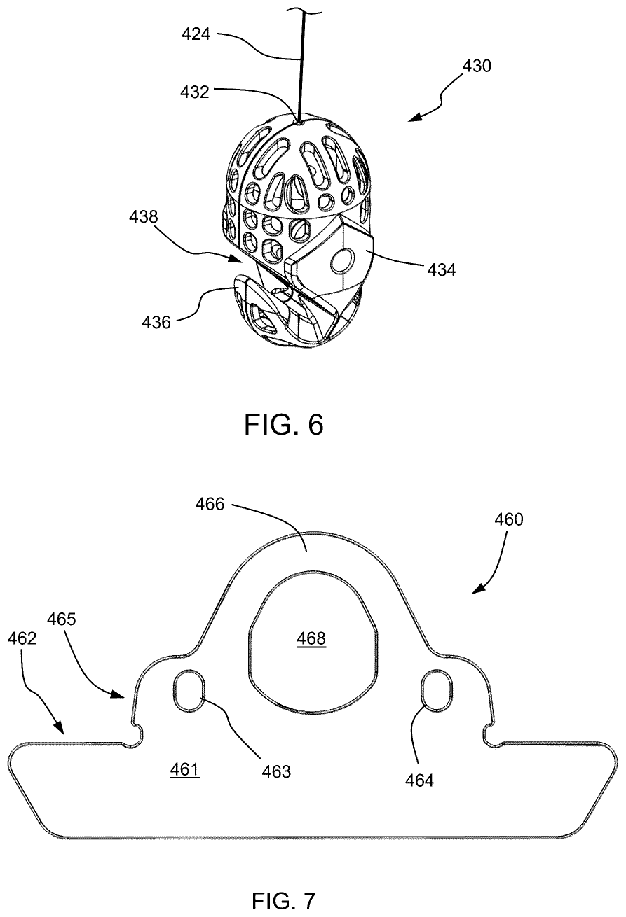

FIG. 6 is a perspective view of payload coupling apparatus or payload retriever 430 according to an example of the disclosure embodiment. The payload retriever 430 includes a tether mounting point 432 at the top of the payload retriever 430 and a slot 438 adapted to receive a handle of a payload. A lip 436 is formed beneath the slot 438 and adapted to support the handle of the payload when it is coupled to the payload retriever 430. The payload retriever 430 may also include outer protrusions 434 that form camming surfaces that are adapted to mate with corresponding surfaces in the UAV to rotate the payload to a predetermined orientation. Corresponding mating surfaces may be included within a receptacle in the fuselage of a UAV.

FIG. 7 is a side view of an example hanger 460 of a payload configured to be carried by a UAV. The example hanger 460 includes a base 462 and a handle 465 that extends up from the base 462. The base 462 is configured to couple to a container of the payload. The handle 465 is formed as a bridge 466 that extends over a handle opening 468. In operation with the example payload retriever 430, the payload retriever 430 may hold the hanger 460 by receiving the bridge 466 in the slot 438, with the lip 436 of the payload retriever 430 passing through the handle opening 468. In other examples, the handle may have another shape. For example, rather than a handle formed as a bridge extending over an opening, the handle may be formed as a catch at the end of an extension, such as having a T shape, where the retriever is configured to seize the arms of the “T.” Other configurations are also possible.

In the illustrated example, the hanger 460 is formed by a flat body 461 of material having a uniform thickness, such that the hanger 460 is in the form of a tab. In other examples, the hanger may have other shapes which may have more three-dimensional variation. For example, the handle of the hanger may be formed as a flexible line, such as cord, that is secured at either end to the base.

Further, the base 462 of the example hanger 460 is formed as a section that extends past the handle 465, this allows the handle 465 to be inserted through a slot in the container 452 of the payload 450. With the base 462 being larger than the slot, the hanger 460 is secured to the container. In other examples, the base of the hanger could function similarly, but be wider than the handle rather than, or in addition to, being longer than the handle. Still, in other examples, the base of the hanger may secure to the container in another manner, such as by including a clamp or fastener that attaches to the container.

The example hanger 460 shown in FIG. 7 also includes a first aperture 463 and a second aperture 464 disposed on opposing sides of the handle opening 468. The first and second apertures 463, 464 are configured to cooperate with the releasable coupler 426 to secure the payload 450 to the UAV. In other examples, the hanger may include other structures, including notches, grooves, slots, hooks, knobs, or others, that cooperate with the releasable coupler. Further, in some examples, the releasable coupler may be configured to secure the hanger without any specific structure on the hanger, such as with a clamp configuration.

### VI. Example Holders for a Liquid Container

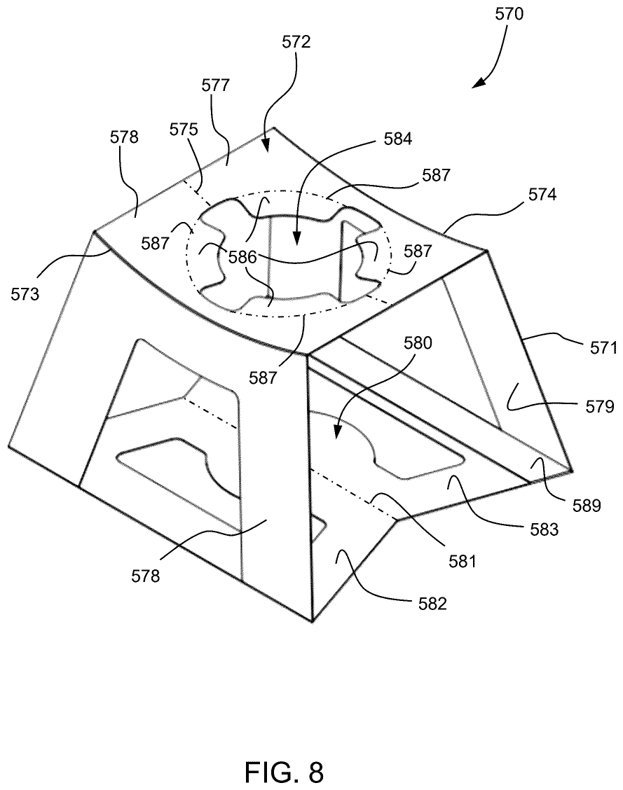

FIG. 8 is a schematic perspective view of a holder 570 for a liquid container according to an example of the disclosure. The holder 570 includes a top panel 572 with a folded first edge 573 on one side and a folded second edge 574 on the opposite side. A first support panel 578 extends down from the top panel 572 along at the first edge 573 and a second support panel 579 extends down from the top panel 572 along the second edge 574. An aperture 584 for securing a liquid container is provided in the top panel 572 and is positioned between the first edge 573 and the opposing second edge 574. The holder 570 may also include a bottom panel 580 that connects the first support panel 578 to the second support panel 579.

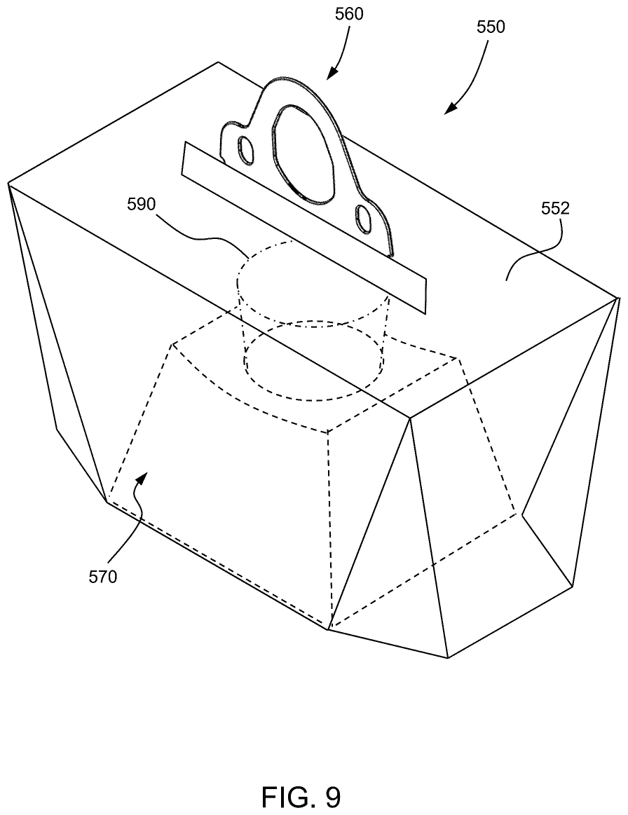

FIG. 9 schematically illustrates the holder 570 inside a package 550 that is operable to be carried by a UAV. The package 550 includes a payload container 552 and a handle 560 that is similar or the same as handle 460 shown in FIG. 7. Accordingly, the package 550 may be retrieved, transported, and delivered in a similar manner to that shown in FIGS. 4A-4C using a payload handling system that is similar or the same as the payload handling system 520 shown in FIG. 5. As illustrated in FIG. 9, the holder 570 supports a liquid container 590, such that the liquid container 590 is held in an upright orientation. The liquid container 590 may take any of various forms, including beverage containers, such as drink cups, food containers, such as soup containers, and liquid medical containers, such as medical sample thermoses. The holder 570 is particularly well suited for supporting liquid containers 590 that are not completely sealed, such as a cup with a press-fit lid that may include holes for straws or venting. In such cases, the holder 570 can help avoid spills by keeping the liquid container 590 upright. A person of ordinary skill in the art will appreciate that substances other than liquids may also be placed in a container like container 590 that are susceptible to being spilled if the container is tipped over would benefit from the advantages of this holder 570.

The holder 570 may be formed of a sheet of material that is cut and folded into a three dimensional configuration for holding a liquid container 590. The term folded, as used herein, refers to any deformation of a sheet of material along a defined crease or bend line, regardless of the angle between the resulting portions. This includes configurations where the sheet is partially bent, as well as those where it is fully folded upon itself. The term encompasses both permanent and temporary folds, including those formed by scoring, creasing, or other controlled bending processes.

In some examples the sheet of material may be formed by a single continuous section of material, while in other examples the sheet of material may be formed by several sections that are attached to each other. In different examples, the sheet can be formed of various different materials. For instance, in some examples, the sheet of material may be formed of a fiber-based construction, such as paper, paper board, or cardboard. Further, in some examples, the material may be formed with features to increase strength and durability. For instance, in some examples, the holder may be formed of a corrugated laminate or reinforced paper board. To protect the holder from any liquid that may spill from the supported liquid container, the material of the container may have a protective coating, such as a polymer film like polyethylene laminate, wax, or other water resistant coating. In other examples, the holder may be formed of another material, such as a plastic, metal, reinforced fabric, fiber glass, carbon fiber, or a combination thereof.

The use of a sheet of material, such as paperboard, to construct the holder of the disclosure offers several advantages in terms of manufacturing efficiency, cost reduction, and ease of deployment. By employing a particular pattern of cuts and folds, a three-dimensional holder can be formed from a flat sheet without requiring complex assembly processes. In some examples, the sheet of material can be die-cut and creased in a single manufacturing step, thereby reducing manufacturing steps. Furthermore, as explained in more detail below, the holder can be stored in a flat configuration until it is deployed, which makes shipping and storage highly space-efficient.

Additionally, flat material sheets can be easily covered with graphics or decals, allowing the holder to be visually appealing and branded without requiring separate labeling or post-assembly decoration. Furthermore, material sheets may be a sustainable option for the material of the holder. For example, paperboard is made from renewable sources and is widely recyclable. Paperboard can also be folded and shaped to have significant structural integrity with low material use and weight, which further reduces the environmental impact of the holder.

As shown in FIG. 8, the top panel 572 of the holder 570 is coupled to the first support panel 578 along a curved crease that follows the first edge 573. Likewise, the top panel 572 is coupled to the second support panel 579 along a curved crease that follows the second edge 574. The term curved, as used herein, refers to any deviation from a straight line or plane that forms a continuous or segmented arc, bend, or contour. This includes smooth, continuously curved surfaces as well as approximations formed by multiple adjoining linear segments that collectively define a curved path. The term encompasses both uniform and non-uniform curvatures, whether formed naturally, through material deformation, or by discrete angular transitions that approximate a curve.

The curved creases between the top panel 572 and the two support panels 578, 579 forms a more stable structure of the holder 570 than if the folds were linear. When a sheet of material is folded along a straight-line crease, the two sections on either side of the crease can be repositioned at any angle relative to one another without introducing internal stresses. This allows for free rotation about the crease, functioning as a simple hinge. However, when a fold is introduced along a curved crease, as in the holder of this disclosure, the resulting deformation imposes geometric constraints that restrict the range of motion and introduce preferred stable positions. Specifically, because the material resists in-plane stretching, the two sections adjacent to the curved crease must undergo out-of-plane bending to accommodate the arc of the curved crease. Accordingly, the top panel 572 and support panels 578, 579 each bend into a curved surface when folded along the respective curved creases 573, 574. This bending creates localized stresses that cause the material to preferentially settle into discrete, stable configurations rather than allowing smooth, continuous rotation.

As a result, the curved creases 573, 574 contribute to the structural stability of the resulting three-dimensional shape of the holder 570 by enabling it to maintain its shape under external forces. The curved creases 573, 574 introduce a form of mechanical resistance that helps the holder 570 retain its intended configuration. When external forces act upon the holder 570, the localized stresses created by the curved creases 573, 574 work against unwanted deformation, effectively reinforcing the structure of the holder 570.

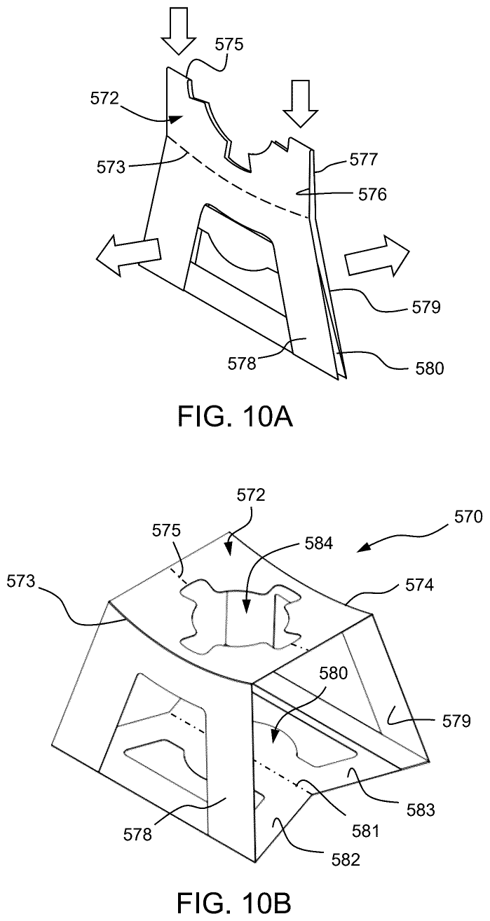

The curved creases 573, 574 between the top panel 572 and support panels 578, 579 also provide the holder 570 with a bistable configuration, as illustrated in FIGS. 10A and 10B. FIG. 10A shows the holder in a collapsed state. As shown, the top panel 572 includes a fold line 575 between a first portion 576 of the top panel 572 and a second portion 577 of the top panel 572. When the holder 570 is in the collapsed state of FIG. 10A, the top panel 572 is folded closed along the fold line 575 with the first portion 576 of the top panel 572 folded against the second portion 577 of the top panel 572. In contrast, the two curved creases 573, 574 are unfolded. Thus, in the collapsed state the first portion 576 of the top panel 572 is substantially coplanar with the first support panel 578. Similarly, when the holder 570 in the collapsed state, the second portion 577 of the top panel 572 is substantially coplanar with the second support panel 579.

The bottom panel 580 may similarly have a fold line 581 that divides the bottom panel 580 into a first portion 582 that is adjacent to the first support panel 578 and a second portion 583 that is adjacent to the second support panel 579. When the holder 570 is in the collapsed state, as shown in FIG. 10A, the bottom panel may be folded closed along the fold line 581 with the first portion 582 of the bottom panel 580 folded against the second portion 583 of the bottom panel 580. Unlike the curved creases 573, 574 along the top panel 572, the bottom panel 580 may be coupled to the first and second support panels 578, 579 along linear folds. As a result, the first and second portions 582, 583 of the bottom panel 580 may be folded at various different angles with respect to the respective support panels 578, 579. This allows the bottom panel 580 to fold upward and rest between the first support panel 578 and second support panel 579, as shown in FIG. 10A, or to fold down. Folding the bottom panel 580 upward, as illustrated, reduces the planar area of the holder 570 in the collapsed state, but adds layers to the folded configuration, thereby increasing its thickness. In contrast, folding the bottom panel 580 downward reduces the thickness, but increases the planar area. Each of these configurations can have advantages for shipping and storage, depending on the available size of shipping boxes and storage space.

The arrows in FIG. 10A illustrate the direction of movement of the surfaces of the holder 570 to move into the operational state that is shown in FIG. 10B and described above. Each of the first support panel 578 and the second support panel 579 move away from one another as the top panel 572 and bottom panel 580 unfold with the fold lines moving downward. Eventually, the holder 570 will pass a transition point in the unfolding and the holder 570 will ‘snap’ into the operational state.

In the illustrated example shown in FIGS. 8-10, the fold line 575 of the top panel 572 and the fold line 581 of the bottom panel 580 are both positioned in the middle of the respective panel. Thus, the fold line 575 of the top panel 572 passes through the middle of the aperture 584. This configuration allows a liquid container 590 (see FIG. 8) positioned in the aperture 584 to promote the stability of the holder in several ways. First, the position of the liquid container 590 in the holder 570 allows the liquid container 590 to act as a structural element of the holder 570 and inhibit shear deformation of the holder 570. Further, with the liquid container 590 positioned inside the aperture 584 of the top panel 572, the fold line 575 of the top panel 572 cannot fold close, as the liquid container is holding the aperture 584 open, and by extension, keeping the top panel 572 unfolded. Thus, the liquid container 590 urges the top panel 572 toward the operational state. Likewise, the liquid container 590 also sits on top of the bottom panel 580, thereby urging the bottom panel 580 to lie flat in the operational state.

Alternatively, in other examples, the fold line 575 of the top panel may be off-center. Such a configuration may be beneficial for various reasons. For example, if the top panel 572 folds along more than one crease when in the collapsed state, there may be advantages to have folds on either side of the top panel, rather than in the center. Likewise, if the holder 570 is integrated into another structure, such as the payload container 552, it may be beneficial for the holder to collapse asymmetrically.

In some examples, the width of the bottom panel 580 between the first support panel 578 and the second support panel 579 is larger than the width of the top panel 572 between the first support panel 578 and the second support panel 579. Accordingly, when the holder 570 is in the operational state, as shown in FIG. 10B, the holder 570 is wider at the base, which provides additional support to a drink held in place by the top panel 572. The two support panels 576, 577 are angled inward such that support panels 576, 577 extend toward any liquid container 590 that is supported by the holder 570.

To maintain the liquid container in the middle of the aperture 584 of the top panel 572, the holder 570 may include a plurality of inwardly extending retaining tabs 586 positioned around the perimeter 587 of the aperture 584, as shown in FIG. 8. The retaining tabs 586 allow liquid containers of various sizes to be inserted into the aperture 584 while still being secured by the holder. Each retaining tab 586 will bend when a container is inserted into the aperture 584 to accommodate the size of the container. Moreover, the retaining tabs 586 can provide a centering force against the container to help keep the container in the center of the holder, thereby increasing the structural integrity of the holder and urging it into the operational state, as explained above.

The aperture 584 may be formed in various different shapes. In the illustrated example, the aperture has a circular perimeter with four retaining tabs extending inward therefrom. In other examples, the aperture may have a perimeter with another shape, such as hexagonal, square, oval, or other shapes. Further, in some examples, the shape of the aperture may be formed to cooperate with a specific object that is being secured by the holder. For instance, the illustrated holder 570 in FIG. 8 is configured to hold a circular cup. But other holders may have apertures shaped to hold objects with other configurations.

In some examples, the retaining tabs 586 may be coupled to the top panel 572 along a respective curved crease 587. The internal stresses associated with folding the retaining tabs 586 along their respective curved crease 587, as explained above, help to impart a force against the liquid container 590 that is held in the aperture 584. Internal resistance to folding along the curved crease 587 allows the retaining tab 586 to push against the surface of the liquid container 590, but still maintains enough flexibility to allow the liquid container 590 to be inserted into the aperture 584. While FIG. 4 depicts four retaining tabs, other numbers of retaining tabs may be employed. It is also possible to form the aperture without any retaining tabs, for example where the liquid container is contained by the perimeter of the aperture directly.

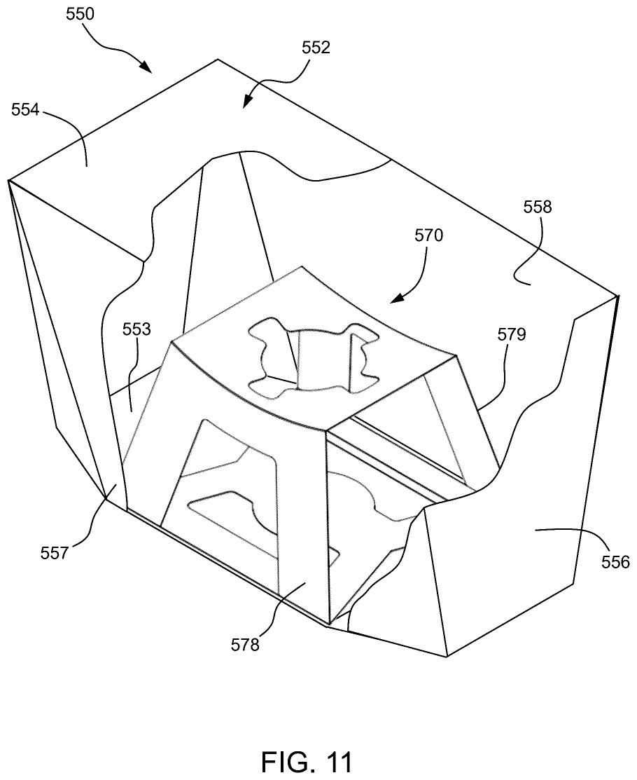

As explained above, the illustrated holder 570 may be configured to cooperate with a package 550 that is adapted for delivery by a UAV. FIG. 11 shows the holder 570 positioned inside the container 552 of package 550 with a portion of the payload container 552 removed to reveal the holder 570. As shown, the container 552 includes a bottom face 553, a closeable top 554 and a side wall 556 extending between the bottom face 553 and the closeable top 554. With the holder 570 set inside the payload container 552, the bottom panel 580 may be supported by the bottom face 553 of the payload container.

In some examples, the holder 570 may be sized to fit securely within the payload container 552 to avoid movement of the holder 570 and any liquid container 590 supported by the holder 570. For example, at least one dimension of the bottom panel 580 of the holder 570 may be substantially the same as a corresponding dimension of the bottom face 553 of the payload container 552, but slightly smaller so that the holder 570 fits inside the payload container 552. For instance, in the illustrated embodiment shown in FIG. 11, the bottom panel 580 is sized so that the first support panel is braced against a first portion 557 of the side wall 556 while the second support panel is braced against a second portion 558 of the side wall 556 that is opposite the first portion 557. As such, the holder 570 is securely held between the two opposing portions 557, 558 of the side wall of the payload container 552.

In some examples, the holder 570 may be placed into the payload container 552 and freely removable therefrom. In other examples, the holder 570 may be adapted for a more secure connection to the payload container 552. For instance, in some examples, the payload container 552 may include adhesive strips on the bottom panel 580 so that the holder 570 can adhere to the bottom face 553 of the payload container 552. In other examples, the holder 570 and payload container 552 may include cooperating tabs and slots, or other mechanical connections to secure the holder 570 inside the payload container 552. Further still, in some examples, the payload container 552 and the holder 570 may form a single assembly. For instance, the holder 570 may be adapted to rest against the side wall 556 of the payload container 552 in the collapsed state until it is needed, at which point it may be converted into the operational state for holding a liquid container.

In some examples, the panels of the holder 570 may include holes for reducing the weight of the holder 570, which may be beneficial in aviation applications, such as UAV delivery. Carefully placed holes can substantially reduce the weight of the holder without significantly impacting its strength or rigidity. Alternatively, in some examples, the panels may be solid and the aperture 584 in the top panel 572 may be the only hole in the material sheet that forms the holder 570.

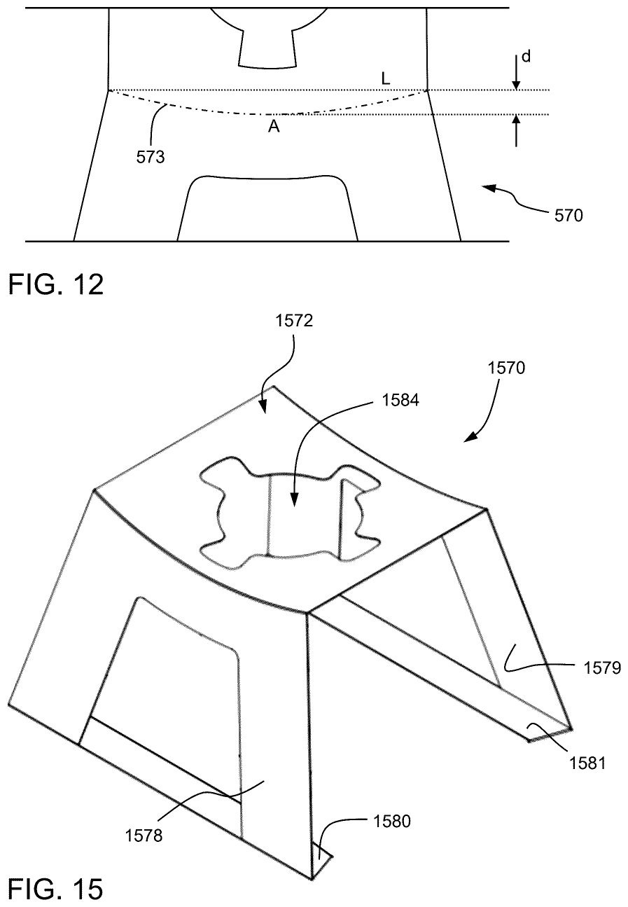

The degree of curvature of the curved creases 573, 574 impacts both the shape of the holder 570 in its operational state and the ease of moving between the collapsed and operational states. To impart a clear bistable configuration to the holder 570, in some embodiments, the curvature of the curved creases curves 573, 574 is greater than a certain threshold. FIG. 12 illustrates a portion of the holder 570, which is in the collapsed state for clarity, that shows the curvature of the curved crease 573. As shown, the curved crease 573 extends to an apex A that is between two ends of the curve. The apex A is set at a distance d from the line extending between the two ends of the curved crease 573. This distance d quantifies the extent of curvature of the curved crease 573. In some examples, the apex A of the first curved crease 573 is spaced by at least 5 mm from the line L extending between the ends of the curved crease 573. Further, in other examples, the curvature is greater, and the spacing is at least 7 mm, or at least 9 mm. The second curved crease 574 may have the same degree of curvature.

In the illustrated example of FIG. 8, the apex of the curved creases 573, 574 is away from the aperture 584, such that the curved creases 573, 574 curve around the aperture. In other examples, the curved creases may curve the opposite direction, with the curvature placing the apexes closer to the aperture. Still, in other examples, one curved crease may curve in one direction, while the other curves in the opposite direction.

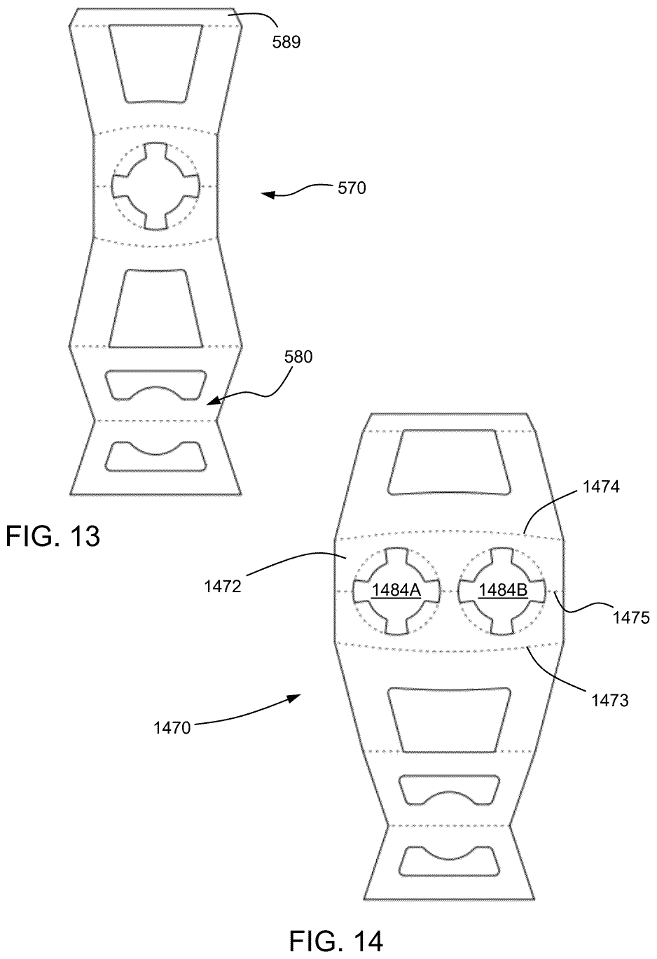

The holder 570 illustrated in FIG. 8 is formed as a loop, where one end of the sheet of material is configured to be secured to the opposite end. Specifically, the holder 570 includes a fastening tab 589 at the end of the second support panel 579 that is secured to the bottom panel 580. Accordingly, as shown in FIG. 13, the sheet of material 571 that forms the holder 570 may be die cut to form all of the panels of the holder 570 from a single flat sheet of material. As shown in FIG. 13, the bottom panel 580 is formed at one end of the die cut material sheet, while the fastening tab 589 is formed at the other. Upon cutting and creasing, the bottom panel 580 and fastening tab 589 may be placed adjacent to one another and secured together.

While the holder 570 shown in FIGS. 8-13 includes a single aperture, in other examples, the holder may include more than one aperture. For instance, FIG. 14 shows a die-cut sheet of material for forming a holder 1470 that includes two apertures 1484A 1484B. To maintain stability, the top panel 1472 includes two creased curves 1473, 1474 at opposing edges, similar to holder 570. Further the fold line 1475 of the top panel 1472 passes through both apertures 1484A, 1484B, so that liquid containers held therein can help maintain the holder 1470 in its operational state.

To form the holder in a loop configuration, the holder may include For instance, in holder 570 illustrated in FIGS. 8-13, the fastening tab 589 may be glued to the bottom panel 580. In other examples, the panels may include tabs, slots, or other fastening structures to secure the holder in a loop configuration. Alternatively, in some examples, the holder may not include a looped configuration. For example, FIG. 15 shows an example of a holder 1570 according to the disclosure that excludes a bottom panel. Instead, the holder 1570 includes a top panel 1572 with an aperture 1584, and opposing first and second support panels 1578, 1579 extending down from the top panel 1572. The opposing first and second support panels may be positioned in a payload container and braced against the side wall of the container to stabilize the drink holder 1570. In the illustrated example, each of the support panels 1578, 1579 includes a folded section forming a respective foot 1580, 1581 that may increase rigidity of the end of the respective support panel 1578, 1579. However, in other examples, the support panels may be formed without such feet.

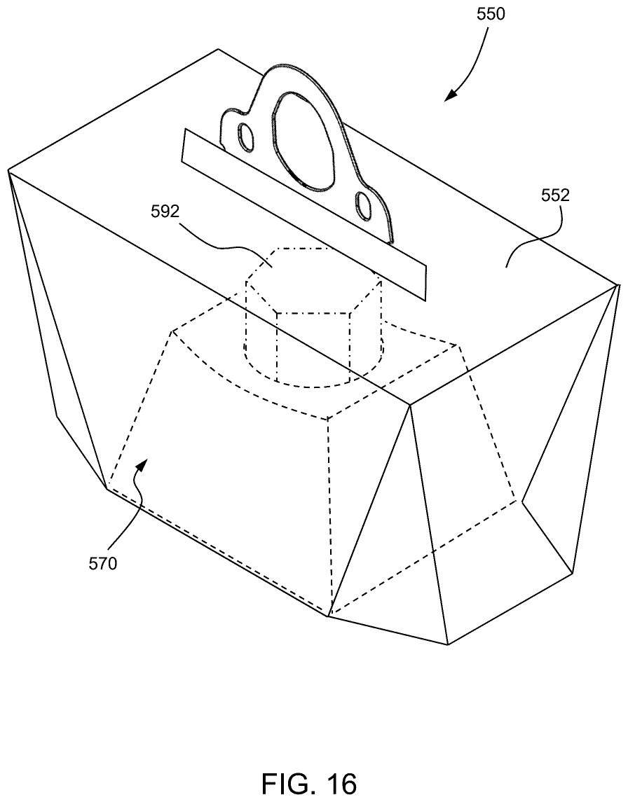

While the holder of the disclosure is described herein with reference to its use to support a liquid container, such a holder would be advantageous in securing other objects within a package for delivery by a UAV. The holder can maintain any object centered and upright within the package. While this has particular advantages for containers that may spill their contents, holding the object in place also has advantages for the transporting and delivery of the package, as centering the object can avoid tipping of the package and swaying of the package, which may otherwise occur if the contents of the package are positioned to one side. FIG. 16 shows the holder 570 holding an object 592 (other than a cylinder) within the payload container 552 of package 550.

### VII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or fewer of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A holder for a liquid container comprising:
a sheet of material that is deployable into an operational state in which the sheet of material forms:
a top panel including a first edge, a second edge opposite the first edge, and an aperture positioned between the first edge and the second edge, wherein the aperture is configured to receive a liquid container,
a first support panel coupled to the first edge of the top panel along a first curved crease and extending down from the top panel, and
a second support panel coupled to the second edge of the top panel along a second curved crease and extending down from the top panel.

2. The holder of claim 1, wherein the sheet of material is also deployable into a collapsed state, and wherein in the collapsed state the first support panel is substantially coplanar with an adjacent first portion of the top panel and the second support panel is substantially coplanar with an adjacent second portion of the top panel.

3. The holder of claim 2, wherein the top panel, the first support and the second support have a bistable configuration.

4. The holder of claim 2, wherein in the collapsed state the top panel is folded along a fold line such that the first portion of the top panel is folded against the second portion of the top panel.

5. The holder of claim 4, wherein the fold line is centrally disposed and runs through the aperture such that a beverage container held in the aperture urges the top panel toward the operational state.

6. The holder of claim 1, wherein the sheet of material further includes a bottom panel coupled to the first support panel and the second support panel, such that the drink holder is formed as a loop.

7. The holder of claim 1, wherein the bottom panel is foldable along a fold line, and wherein the fold line is positioned such that the liquid container, when inserted in the aperture, urges the bottom panel to lie flat.

8. The holder of claim 1, wherein a plurality of inwardly extending retaining tabs are disposed around the perimeter of the aperture.

9. The holder of claim 8, wherein each of the retaining tabs is coupled to the top panel along a curved crease.

10. The holder of claim 1, wherein the top panel includes a second aperture positioned between the first edge and the second edge for holding a second liquid container.

11. The holder of claim 1, wherein an apex of the first curved crease is spaced at least 5 mm from a line extending between opposing ends of the first curved crease.

12. The holder of claim 1, wherein the sheet of material is formed of paperboard.

13. A package for holding a liquid container and adapted for use with a UAV, the package comprising:
a payload container including:
a bottom face,
a closeable top, and
a side wall extending between the bottom face and the closeable top; and
a holder for a liquid container positioned inside the payload container, the holder including a sheet of material that is folded in an operational state and forms:
a top panel including a first edge, a second edge opposite the first edge, and an aperture positioned between the first edge and the second edge, wherein the aperture is configured to receive a liquid container,
a first support panel coupled to the first edge of the top panel along a first curved crease and extending down from the top panel, and
a second support panel coupled to the second edge of the top panel along a second curved crease and extending down from the top panel.

14. The package of claim 13, wherein the first support panel of the holder is braced against a first portion of the side wall of the payload container, and the second support panel of the holder is braced against an opposing second portion of the side wall of the payload container.

15. The package of claim 13, wherein the holder has a bistable configuration and is adapted to be movable into a collapsed state, and wherein in the collapsed state the first support panel is substantially coplanar with an adjacent first portion of the top panel and the second support panel is substantially coplanar with an adjacent second portion of the top panel.

16. The package of claim 15, wherein in the collapsed state the top panel is folded along a fold line such that the first portion of the top panel is folded against the second portion of the top panel.

17. The package of claim 16, wherein the fold line is centrally disposed and runs through the aperture such that a liquid container held in the aperture urges the top panel toward the operational state.

18. The package of claim 13, wherein the holder further includes a bottom panel coupled to the first support panel and the second support panel, such that the drink holder is formed as a loop.

19. The package of claim 18, wherein the bottom panel is foldable along a fold line, and wherein the fold line is positioned such that the liquid container, when inserted in the aperture, urges the bottom panel to lie flat.

20. The package of claim 13, wherein a plurality of inwardly extending retaining tabs are disposed around the perimeter of the aperture.
